(19) United States
(12) Patent Application Publication
(10) Pub. No.: US 2021/0037972 A1
(43) Pub. Date: Feb. 11, 2021

(54) GUIDE RAIL, AND STORAGE APPARATUS AND REFRIGERATOR HAVING SAME

(71) Applicant: Samsung Electronics Co., Ltd., Suwon-si (KR)

(72) Inventors: Eunbi SEO, Suwon-si (KR); Yangyeol GU, Suwon-si (KR); Kwonchul YUN, Suwon-si (KR); Youngbae HONG, Suwon-si (KR)

(21) Appl. No.: 16/964,955

(22) PCT Filed: Jan. 24, 2019
(86) PCT No.: PCT/KR2019/001006

§ 371 Date: Jul. 24, 2020

(30) Foreign Application Priority Data
Jan. 26, 2018 (KR) 10-2018-0009849

(51) Int. Cl. A47B 88/493; F25D 23/06; F16C 29/00

(52) U.S. Cl. CPC A47B 88/493; F25D 23/062; F16C 29/005; A47B 2210/004; A47B 2210/0008; A47B 2210/001; A47B 2210/0005

(57) ABSTRACT

Disclosed are a guide rail for allowing a drawer to be smoothly opened and closed, and a storage apparatus and a refrigerator having the same. The refrigerator includes a drawer accommodating room; a drawer accommodated in the drawer accommodating room; and a rail configured to guide the drawer to be pulled out of or pushed into the drawer accommodating room. The rail includes a first member extended along pulling-out or pushing-in directions of the drawer and supporting the drawer; a second member extended corresponding to the first member and supported in the drawer accommodating room of the refrigerator; and a plurality of rolling elements arranged between the first member and the second member and being in rolling-contact with the first member and the second member when the drawer is pulled out or pushed in. The second member includes a load support surface having an inward height difference as much as a predetermined gap from a rolling contact surface with which at least one second rolling element different from a first rolling element among the plurality of rolling elements is in rolling-contact so that at least one of the first rolling elements among the plurality of rolling elements is in contact with the first member and the second member and support a load of the drawer in a state that the drawer is positioned in at least one of a critical pull-out section or a critical push-in section. Thus, the refrigerator equally maintains a degree of contact between the rolling element and the members while the guide rail works, thereby uniformizing the operation quality of the guide rail.

### CROSS-REFERENCE TO RELATED APPLICATIONS

This application is a 371 National Stage of International Application No. PCT/KR2019/001006 filed on Jan. 24, 2019, which claims priority to Korean Patent Application No. 10-2018-0009849 filed on Jan. 26, 2018, the disclosures of which are herein incorporated by reference in their entirety.

### BACKGROUND

### 1. Field

The disclosure relates to a guide rail, and a storage apparatus and a refrigerator having the same, and more particularly to a guide rail for allowing a drawer to be smoothly opened and closed, and a storage apparatus and a refrigerator having the same.

### 2. Description of Related Art

In general, a storage apparatus with a drawer includes a guide rail to guide the drawer to be pulled out of and pushed into a drawer accommodating room provided in a mounting target device. The guide rail usually includes a rolling element such as a ball or a roller disposed between inner members to keep the drawer stably movable with respect to the drawer accommodating room.

The rolling element is often made of steel to stably guide the drawer, which is kept movable by the guide rail, even under a high mechanical load due to heavy weight. However, the steel rolling element has shortcomings that may make loud noise while rolling.

It has been known to use a plastic rolling element to reduce the rolling noise. However, there is a problem that the plastic rolling element is reversibly deformed during a rolling operation. The reversible deformation causes the guide rail to initially vibrate and finally make running noise (e.g. “to sound rattled”).

To prevent such a problem, there has been known a guide rail in which a retainer for accommodating a plurality of rolling elements different in diameter from one another is disposed between an inner member and a middle member. In this case, while the drawer is pulled out of or pushed into the drawer accommodating room, the guide rail guides the drawer with contact between the rolling element having a large diameter and the members when the drawer is lightweight, and with contact between the rolling elements having the large diameter and a small diameter and the inner member as the load of the drawer causes the inner member to sag when the drawer is heavy.

However, such a guide rail is varied in a position and degree of contact between the rolling element and the members of the guide rail depending on the diameter or position of the rolling element, and it is therefore difficult to uniformize the operation quality of the guide rail.

The disclosure is to provide a guide rail, in which rolling elements of the same size are used to equally maintain a degree of contact between a rolling element and inner members without adding a rolling element of a different size and therefore operation quality is uniformized, and a storage apparatus and a refrigerator including the same.

Further, the disclosure is to provide a guide rail, in which a rolling element can stably support a load of a drawer when the drawer is positioned in a critical pull-out section and/or a critical push-in section, and a storage apparatus and a refrigerator including the same.

### SUMMARY

According to an embodiment of the disclosure, a refrigerator includes: a drawer accommodating room; a drawer accommodated in the drawer accommodating room; and a rail configured to guide the drawer to be pulled out of or pushed into the drawer accommodating room, wherein the rail includes: a first member extended along pulling-out or pushing-in directions of the drawer and supporting the drawer; a second member extended corresponding to the first member and supported in the drawer accommodating room of the refrigerator; and a plurality of rolling elements arranged between the first member and the second member and being in rolling-contact with the first member and the second member when the drawer is pulled out or pushed in, and the second member includes a load support surface having an inward height difference as much as a predetermined gap from a rolling contact surface with which at least one second rolling element different from a first rolling element among the plurality of rolling elements is in rolling-contact so that at least one of the first rolling elements among the plurality of rolling elements can be in contact with the first member and the second member and support a load of the drawer in a state that the drawer is positioned in at least one of a critical pull-out section or a critical push-in section.

Thus, the refrigerator equally maintains a degree of contact between the rolling element and the members on the rolling contact surface of the second member while the guide rail works, thereby uniformizing the operation quality. Further, when the drawer is positioned in the critical pull-out section or the critical push-in section, the first rolling element can be further in contact with the load support surface of the second member having the height difference as much as a predetermined gap from the rolling contact surface, thereby stably supporting the load of the drawer.

The plurality of rolling elements may be of the same size. Thus, there are no needs of preparing the rolling elements of different sizes. Further, the guide rail employs the rolling elements of the same size, and thus equally maintains a degree of contact with the second rolling element on the rolling contact surface of the second member, thereby uniformizing the operation quality.

The at least one first rolling element and the at least one second rolling element may be different in material, and the at least one first rolling element may have higher stiffness than the at least one second rolling element. Thus, the first rolling element stably support the load of the drawer while the drawer is being positioned in the critical pull-out section or the critical push-in section, and maintain a stable function even though it is used for a long time.

The second member may include a load supporting portion formed with the load support surface, of which stiffness is higher than a rolling contact portion formed with the rolling contact surface. Thus, the second member stably supports the load of the drawer while the drawer is positioned in the critical pull-out section or the critical push-in section, and maintain a stable function even though it is used for a long time.

The second member may include a load supporting portion formed with the load support surface separately from a rolling contact portion formed with the rolling contact surface. Thus, the second member may be machined by various methods.

The rail may further include a movement retainer freely movable in a space between the first member and the rolling contact surface, and accommodating the at least one different second rolling element; and a stationary retainer stationarily placed in a space between the first member and the load support surface, and accommodating the at least one first rolling element. Further, the load support surface may include a first stopper to restrict movement of the stationary retainer, and the rolling contact surface may include a second stopper to restrict movement of the movement retainer. Further, the stationary retainer may include a ‘C’-shape so that at least two first rolling elements can be in contact with the first member and the second member, and the movement retainer may include a ‘C’-shape so that at least two second rolling elements can be in contact with the first member and the second member. Thus, the plurality of rolling elements can be stably arranged between the first member and the second member.

Alternatively, the load support surface may include a plurality of grooves including a depth as much as the predetermined gap on the rolling contact surface and accommodating the at least one first rolling element. Thus, the load support surface may be machined by various methods.

The predetermined gap may range from 0.01 mm to 0.1 mm (±tolerance). In other words, the predetermined gap may be large enough to prevent the at least one second rolling element together with the at least one first rolling element from exceeding a yield point based on a compressive force received from the first and second members in the state that the drawer is positioned in the critical pull-out section.

The rail may further include a frame fastened to the drawer accommodating room; a third member supported on the frame; and a plurality of third rolling elements arranged between the third member and the second member, and the second member may be configured to be in rolling-contact with the plurality of third rolling elements and slide the third member when the drawer is pulled out or pushed in. Thus, the second member of the rail is supported in the drawer accommodating room while sliding along the third member when the drawer is pulled out or pushed in.

According to an embodiment of the disclosure, a storage apparatus includes a drawer accommodated in the drawer accommodating room; and a rail configured to guide the drawer to be pulled out of or pushed into a drawer accommodating room, wherein the rail includes: a first member extended along pulling-out or pushing-in directions of the drawer and supporting the drawer; a second member extended corresponding to the first member and supported in the drawer accommodating room of the refrigerator; and a plurality of rolling elements arranged between the first member and the second member and being in rolling-contact with the first member and the second member when the drawer is pulled out or pushed in, and the second member includes a load support surface having an inward height difference as much as a predetermined gap from a rolling contact surface with which at least one different second rolling element among the plurality of rolling elements is in rolling-contact so that at least one of the first rolling elements among the plurality of rolling elements can be in contact with the first member and the second member and support a load of the drawer is a state that the drawer is positioned in at least one of a critical pull-out section or a critical push-in section.

Thus, the storage apparatus equally maintains a degree of contact between the rolling element and the members on the rolling contact surface of the second member while the guide rail works, thereby uniformizing the operation quality. Further, when the drawer is positioned in the critical pull-out section or the critical push-in section, the first rolling element can be further in contact with the load support surface of the second member having the height difference as much as a predetermined gap from the rolling contact surface, thereby stably supporting the load of the drawer.

According to an embodiment of the disclosure, a guide rail guides a drawer to be pulled out of or pushed into a drawer accommodating room, wherein the guide rail includes: a first member extended along pulling-out or pushing-in directions of the drawer and supporting the drawer; a second member extended corresponding to the first member and supported in the drawer accommodating room of the refrigerator; and a plurality of rolling elements arranged between the first member and the second member and being in rolling-contact with the first member and the second member when the drawer is pulled out or pushed in, and the second member includes a load support surface having an inward height difference as much as a predetermined gap from a rolling contact surface with which at least one different second rolling element among the plurality of rolling elements is in rolling-contact so that at least one of the first rolling elements among the plurality of rolling elements can be in contact with the first member and the second member and support a load of the drawer is a state that the drawer is positioned in at least one of a critical pull-out section or a critical push-in section.

Thus, the guide rail equally maintains a degree of contact between the rolling element and the members on the rolling contact surface of the second member while the guide rail works, thereby uniformizing the operation quality. Further, when the drawer is positioned in the critical pull-out section or the critical push-in section, the first rolling element can be further in contact with the load support surface of the second member having the height difference as much as a predetermined gap from the rolling contact surface, thereby stably supporting the load of the drawer.

### BRIEF DESCRIPTION OF THE DRAWINGS

FIG. 1 is a schematic perspective view showing the inside of a refrigerator to which a guide rail according to an embodiment of the disclosure is applied,

FIGS. 2 and 4 are perspective views showing that a drawer is partially pulled out of a drawer accommodating room and positioned in a critical pull-out section in a refrigerator to which a guide rail according to an embodiment of the disclosure is applied,

FIG. 3 is a partial cross-sectional view of a drawer-type storage in the refrigerator of FIG. 2 when viewed from front,

FIG. 5 is an exploded perspective view of a guide rail according to an embodiment of the disclosure,

FIG. 6 is a schematic perspective view of a guide rail according to an embodiment of the disclosure,

FIG. 7 is a lateral view showing the guide rail of FIG. 2,

FIGS. 8 and 9 are partial cross-sectional views respectively taken along lines VIII-VIII and IX-IX of FIG. 7,

FIG. 10 is a lateral view of the guide rail of FIG. 4,

FIG. 11 is a partial cross-sectional view taken along a line XI-XI of FIG. 10,

FIG. 12 is a view illustrating that an inner surface of a movement member of the guide rail of FIG. 10 is in contact with a rolling element,

FIG. 13 is a partial perspective view showing an alternative example of a load supporting portion of a middle member in a guide rail according to an embodiment of the disclosure,

FIG. 14 is a partial cross-sectional view showing an alternative example of a guide rail according to an embodiment of the disclosure,

FIG. 15 is a front view showing one end portion of a middle member in a guide rail according to an embodiment of the disclosure, and

FIG. 16 is a view illustrating that a rear end portion of a middle member of a guide rail is in contact with an inner surface of a stationary member by a rolling element when a drawer is positioned in a critical push-in section.

### DETAILED DESCRIPTION

Below, embodiments of the disclosure will be described in detail with reference to accompanying drawings. In the drawings, like numerals or symbols refer to elements for performing substantially the same function, and the sizes of the elements may be exaggerated for clarity and convenience of description.

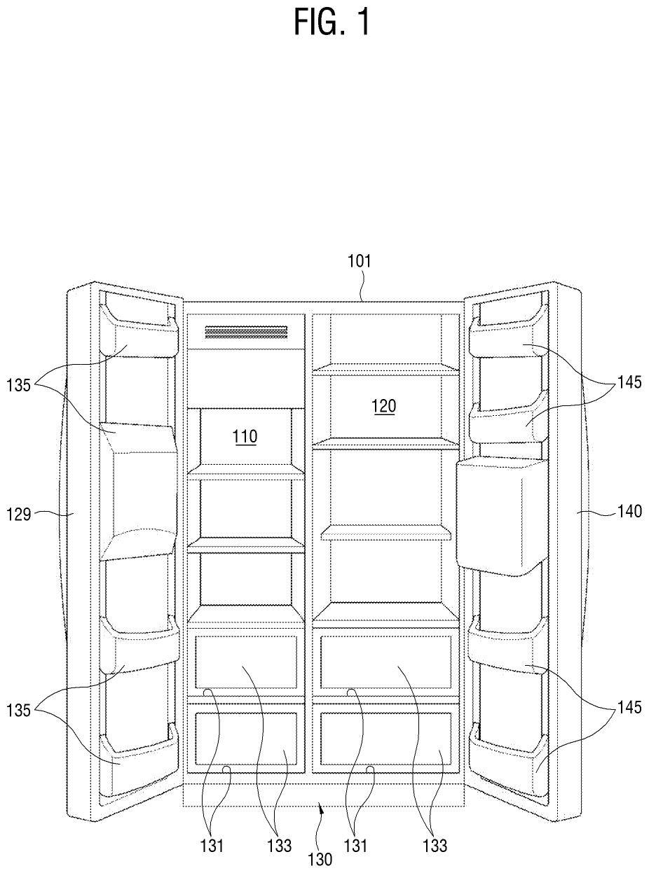

FIG. 1 illustrates the inside of a refrigerator 100 to which a guide rail according to an embodiment of the disclosure is applied.

Referring to FIG. 1, the refrigerator 100 includes a freezer compartment 110, a refrigerator compartment 120, and a drawer-type storage 130 partitioned inside a main body casing 101. The freezer compartment 110, the refrigerator compartment 120 and the drawer-type storage 130 are opened at one side to put food therein and take food out of them, and the opened sides thereof are opened and closed by a freezer compartment door 129 and the refrigerator compartment door 140.

The freezer compartment 110 and the refrigerator compartment 120 include shelves to keep food thereon, and the freezer compartment door 129 and the refrigerator compartment door 140 respectively include pocket-type storages 135 and 145.

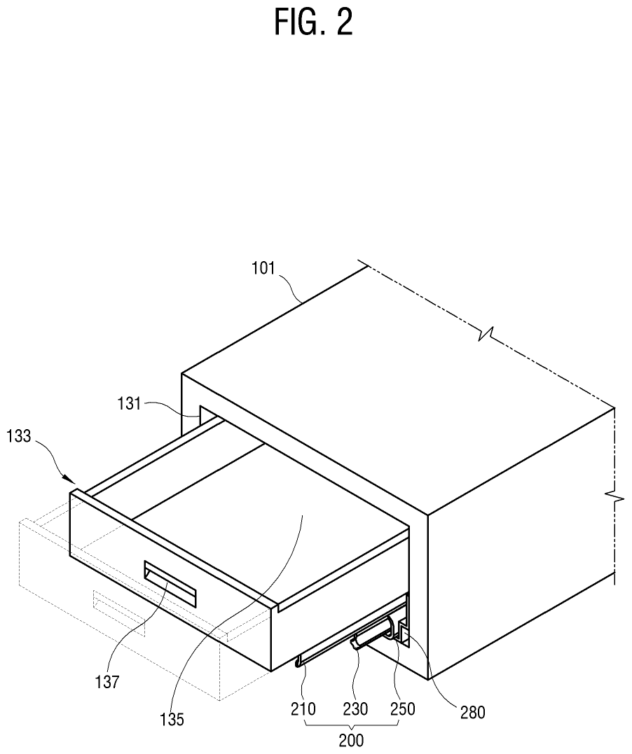

The drawer-type storage 130 refers to a storage apparatus for storing food, and includes a drawer accommodating room 131, a drawer 133, and a guide rail 200 (see FIG. 2).

The drawer accommodating room 131 is provided in lower portions of the freezer compartment 110 and the refrigerator compartment 120, and a plurality of drawer accommodating rooms 131 are partitioned inside the main body casing 101.

Each of the plurality of drawer accommodating rooms 131 is provided with the drawer 133 to be pulled out of or pushed into the drawer accommodating room 131.

A plurality of drawers 133 are each formed to include an accommodating portion 135 shaped like a box and formed to accommodate food, and a handle 137 provided in the front thereof so that a user can pull or push the drawer 133.

The guide rail 200 is fastened to left and right bottoms of each drawer 133 along a lengthwise direction.

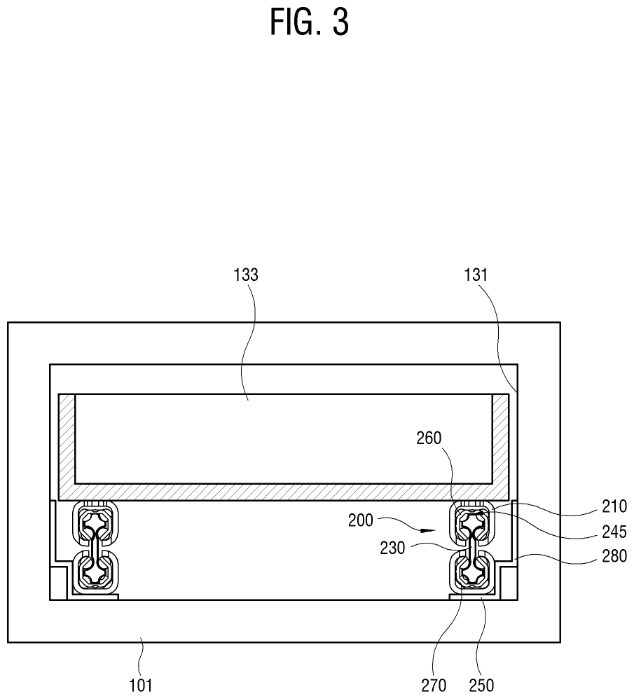

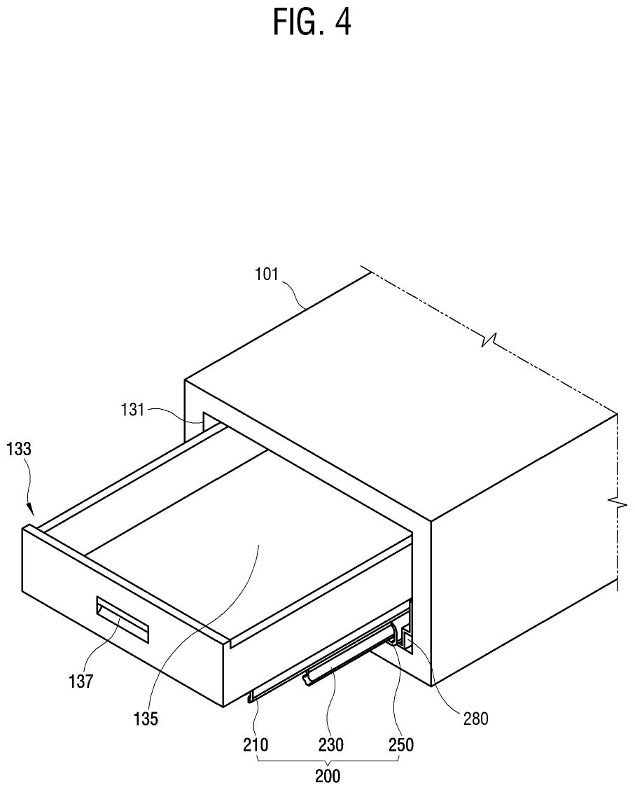

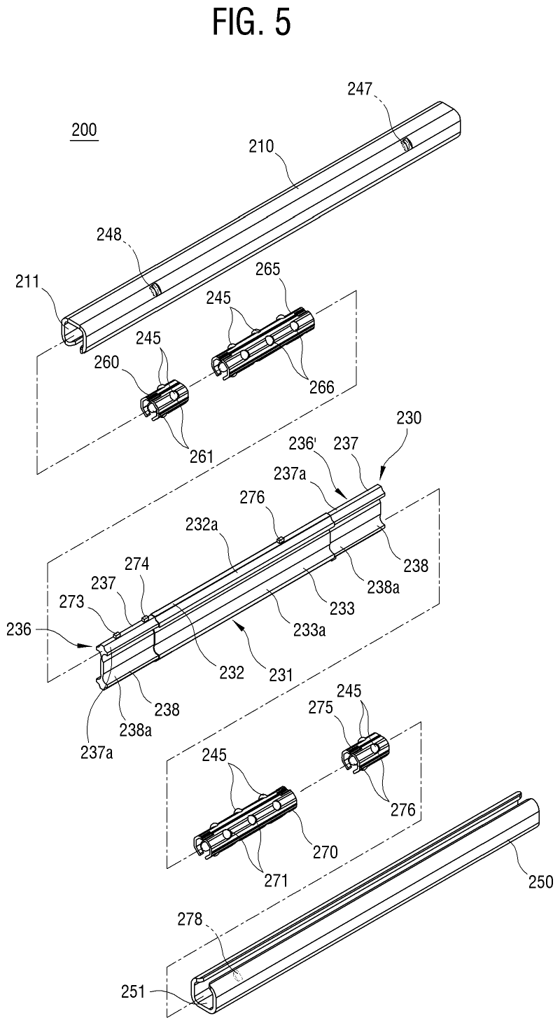

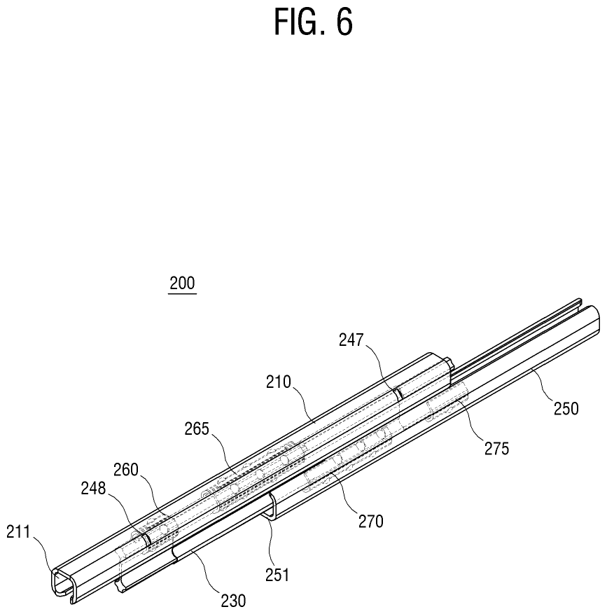

FIGS. 2 and 4 are perspective views showing that the drawer 133 is partially pulled out of the drawer accommodating room 131 and positioned in a critical pull-out section in the refrigerator to which the guide rail 200 according to an embodiment of the disclosure is applied, FIG. 3 is a partial cross-sectional view of a drawer-type storage in the refrigerator of FIG. 2 when viewed from front, and FIGS. 5 and 6 are an exploded perspective view and a schematic perspective view of the guide rail 200 according to an embodiment of the disclosure,

The guide rails 200 placed on the left and right bottoms of each drawer 133 have the same structure except that they are symmetrical to each other, and therefore only the guide rail 200 placed on the right bottom of the drawer 133 will be described for convenience of description.

Referring to FIGS. 2 to 6, the guide rail 200 guides the drawer 133 to be pulled out of or pushed into the drawer accommodating room 131. To this end, the guide rail 200 includes a movement member 210, a rolling element 245, a middle member 230, and a stationary member 250.

The movement member 210 refers to an inner member that moves together with the drawer 133, and is fastened to the bottom of the drawer 133 so as to support the drawer 133. The movement member 210 is disposed to be extended along pulling-out or pushing-in directions of the drawer 133 in order to support the drawer 133 in the pulling-out or pushing-in directions.

Inside the movement member 210, a sliding space 211 is formed to form a track along which the upper portion of the middle member 230 moves.

The movement member 210 is formed as a long member having a ‘C’-shaped cross-section opened downward. However, the disclosure is not limited to this, but may be designed to have another shape.

The middle member 230 refers to a reinforcing member to reinforce the strength of the movement member 210 and the stationary member 250 against a load of food stored in the drawer 133, and is disposed under the movement member 210.

As shown in FIG. 5, the middle member 230 includes a rolling contact portion 231 and first and second load supporting portions 236 and 236′ according to the disclosure.

The rolling contact portion 231 refers to a portion with which the rolling element 245 is in rolling-contact throughout the whole section in which the drawer 133 is put into or pulled out of the drawer accommodating room 131, and includes an upper rolling-contact surface 232 and a lower rolling-contact surface 233.

The upper rolling-contact surface 232 and the lower rolling-contact surface 233 are movably inserted in a movement sliding space 211 of the movement member 210 and a stationary sliding space 251 of the stationary member 250, respectively. Each of the upper and lower rolling-contact surfaces 232 and 233 includes four lengthwise track grooves 232a and 233a to be in the rolling-contact with the rolling element 245 in four directions corresponding to four corners of a cross-section of an approximate crisscross, i.e. at upper and lower opposite sides.

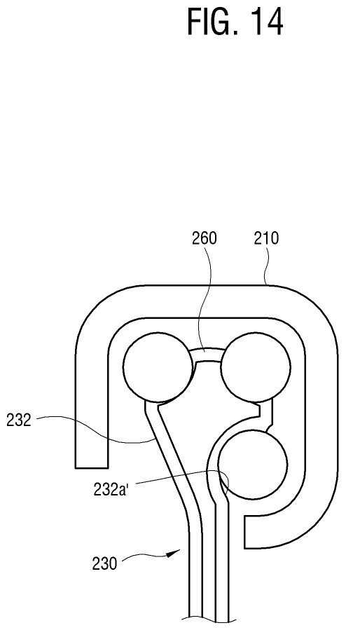

Alternatively, instead of the four lengthwise track grooves 232a and 233a, the upper and lower rolling-contact surfaces 232 and 233 may include three lengthwise track grooves (232a′; only the track grooves of the upper rolling-contact surface) to be in the rolling-contact with the rolling element 245 in three directions (for example, two upper sides and one lower side) corresponding to three corners of a cross-section as shown in FIG. 14, or may include two lengthwise track grooves (not shown) to be in the rolling-contact with the rolling element 245 in two directions corresponding to two corners of a cross-section.

The first and second load supporting portions 236 and 236′ are placed at front and rear ends (i.e. the left end and the right end in the drawings) of the middle member 230. The first and second load supporting portions 236 and 236′ have the same structure except that their upper and lower portions are symmetrical to each other. Therefore, for convenience of description, only the first load supporting portion 236 will be representatively described to describe the structures of the first and second load supporting portions 236 and 236′.

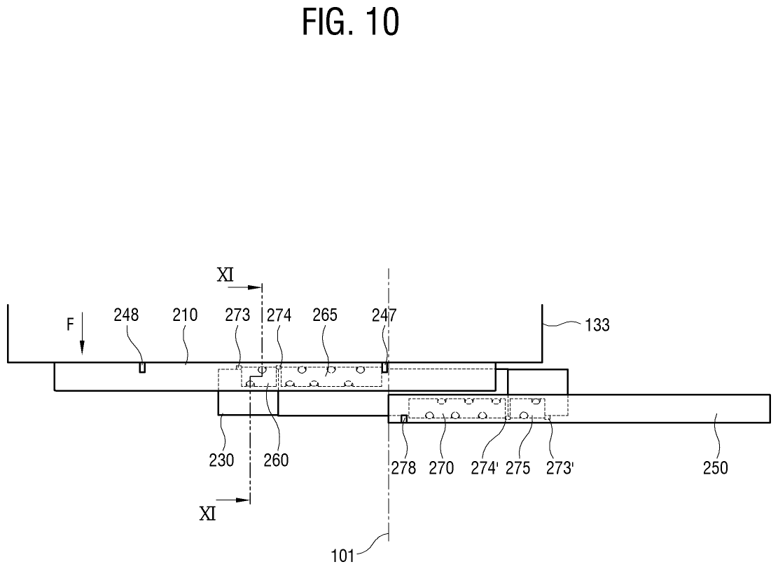

The first load supporting portion 236 refers to a portion that is in contact with the rolling element 245 when the drawer 133 is positioned in the critical pull-out section (see FIGS. 4 and 10) to thereby not only support the load of the drawer 133 but also enable the rolling-contact with the rolling element 245 according to a user's pushing-in or pulling-out operation, and includes upper and lower load support surfaces 237 and 238.

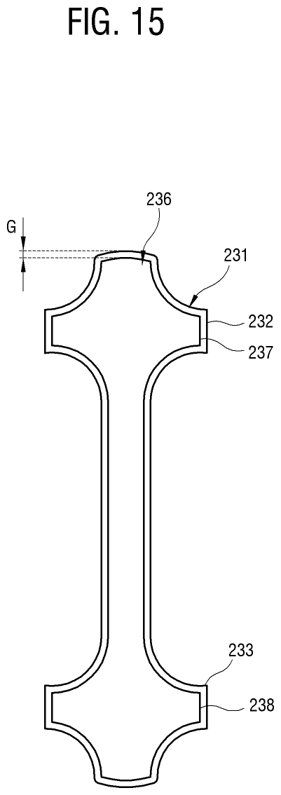

As shown in FIGS. 5 and 15, the upper and lower load support surfaces 237 and 238 has the same features as the upper and lower rolling-contact surfaces 232 and 233 except that they have an inward height difference as much as a predetermined gap G from the upper and lower rolling-contact surfaces 232 and 233.

The predetermined gap G is large enough to prevent the rolling element 245 positioned inside the movement sliding space 211 corresponding to the upper rolling-contact surface 232 from exceeding a yield point even when receiving a compressive force from the upper rolling-contact surface 232 of the middle member 230 and the movement member 210 by the load of the drawer 133 in the state that the drawer 133 is positioned in the critical pull-out section. In this case, the compressive force acts on not only the rolling element 245 positioned corresponding to the upper rolling-contact surface 232 but also the rolling element 245 positioned corresponding to the upper load support surface 237. In this embodiment, a predetermined gap G may, for example, range from 0.01 mm to 0.1 mm (±tolerance).

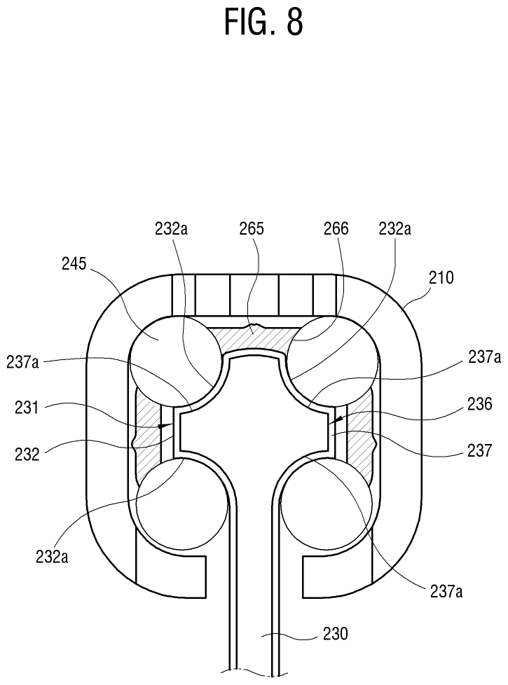

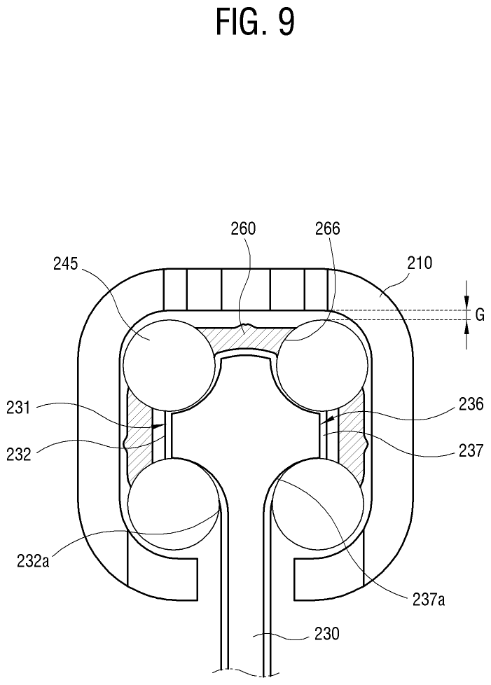

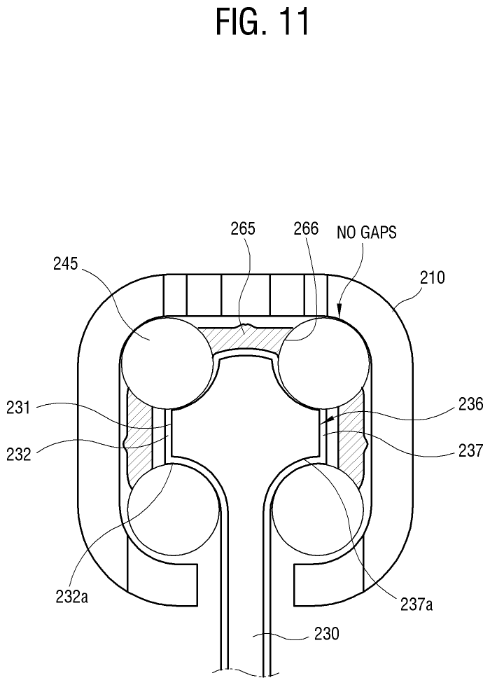

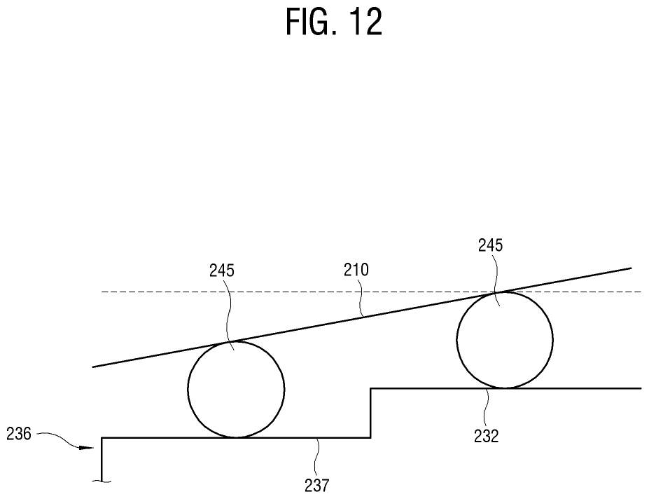

Thus, the movement member 210 is slightly inclined from a dotted line position to a solid line position of FIG. 12 by the load of the drawer 133 in the state that the drawer 133 is positioned in the critical pull-out section, because the upper load support surface 237 has the height difference as much as the predetermined gap from the upper rolling-contact surface 232. Therefore, the inner surface of the movement member 210 is in contact with both the rolling element 245 positioned corresponding to the upper rolling-contact surface 232 and the rolling element 245 positioned corresponding to the upper load support surface 237. In result, unlike a rolling-contact section (see FIGS. 8 and 9) in which only the rolling element 245 positioned corresponding to the upper rolling-contact surface 232 is in the rolling-contact but the rolling element 245 positioned corresponding to the upper load support surface 237 keeps the predetermined gap G, the rolling element 245 positioned corresponding to the upper load support surface 237 is also in the rolling-contact (see FIG. 11), thereby stably supporting the load of the drawer 133. Further, when the drawer 133 starts being pushed again from the critical pull-out section, the rolling element 245 positioned corresponding to the upper load support surface 237 becomes again in the rolling-contact with the inner surface of the movement member 210 and the upper load support surface 237, thereby assisting the movement of the movement member 210.

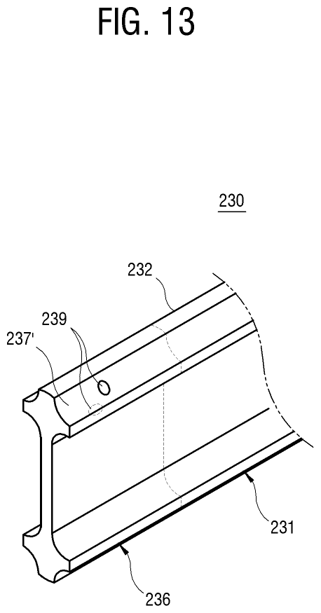

Here, it is illustrated that the upper load support surface 237 has the inward height difference as much as the predetermined gap G from the upper rolling-contact surface 232, but the disclosure is not limited to this. For example, as shown in FIG. 13, an upper load support surface 237′ may include a plurality of grooves 239 formed on the same plane as the upper rolling-contact surface 232 without the height difference and accommodating the rolling elements 245 therein. In this case, the plurality of grooves 239 may have an inward depth as much as the predetermined gap G with respect to the upper rolling-contact surface 232 and the upper load support surface 237′.

Further, both the upper and lower load support surfaces 237 and 238 have the inward height difference as much as the predetermined gap G from the upper and lower rolling-contact surfaces 232 and 233, but the disclosure is not limited to this. For example, only the upper load support surface 237 between the upper and lower load support surfaces 237 and 238 may have the inward height difference as much as the predetermined gap G from the upper rolling-contact surface 232. The reason is because there are no rolling elements 245 to be in the rolling-contact with a lower load support surface 238 when the drawer 133 is positioned in the critical pull-out section, which will be described later with reference to FIG. 10.

The second load supporting portion 236′ has the same structure as the first load supporting portion 236 except that their upper and lower portions are symmetrical to each other as mentioned above.

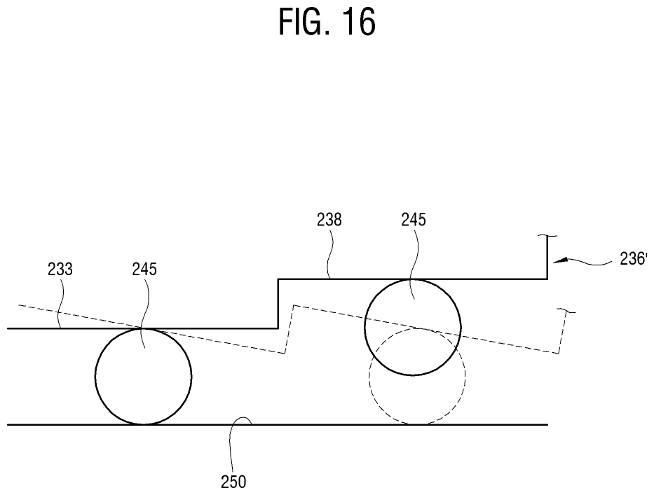

The second load supporting portion 236′ has the lower load support surface 238 to be in contact with the rolling element 245 in the critical push-in section in which the drawer 133 is pushed in as much as possible. In more detail, when the drawer 133 is positioned in the critical push-in section, the load of the drawer 133 applied to the movement member 210 is transferred to the rolling element 245 being in the rolling-contact with the corresponding lower rolling-contact surface 233, as shown with the solid line in FIG. 16, through the rolling element 245 being in contact with the upper rolling-contact surface 232 of the rolling contact portion 231. In result, the middle member 230 is rolling-supported by the rolling element 240 being in the rolling-contact with the lower rolling-contact surface 233. In this case, when a user instantaneously lifts up the front end of the drawer 133 while the drawer 133 is moved to the critical push-in section, the rear end portion (i.e. the right end portion in FIG. 16) of the middle member 230 is slightly inclined frontward as shown with the dotted line in FIG. 16 by the force transferred from the movement member 210. Therefore, the rolling element 240 of a lower stationary retainer 275 (to be described later) is in the rolling-contact with the corresponding surfaces between the lower load supporting surface 238 of the second load supporting portion 236′ and the inner surface of the stationary member 250 until the rear end portion of the movement member 210 is returned to a horizontal status as the force applied by the user is released. In result, it is possible to relieve a shock applied to the rolling element 240 being in the rolling-contact with the lower rolling-contact surface 233.

The middle member 230 is formed by molding or machining one T-shaped member. In the latter case, the first and second load supporting portions 236 and 236′ formed with the upper and lower load support surfaces 237 and 238 may be subjected to heat treatment to have higher stiffness than the rolling contact portion 231 formed with the upper and lower rolling-contact surfaces 232 and 233.

Further, alternatively, the middle member 230 may be formed by coupling a separately machined rolling contact portion 231 and the first and second load supporting portions 236 and 236′. In this case, the first and second load supporting portions 236 and 236′ may be made of a material having higher stiffness than the rolling contact portion 231.

Like this, the first and second load supporting portions 236 and 236′ are formed to have higher stiffness than the rolling contact portion 231, so that the middle member 230 can stably support the load of the drawer 133 while the drawer 133 is positioned in the critical pull-out section or the critical push-in section and maintain a stable function without being broken even through it is used for a long time.

Further, when the movement member 210 moves as a user pulls or pushes the drawer 133, the middle member 230 moves along the movement sliding space 211 and the stationary sliding space 251 by the first and second interlockers 247 and 248 of the movement member 210.

The first and second interlockers 247 and 248 may be embodied by first and second projections formed protruding from left and right portions on the inner surface of the movement member 210. The first and second interlockers 247 and 248 are formed to move the movement member 210 interlocking with an upper movement retainer 265 and an upper stationary retainer 260 (to be described later) when the movement member 210 moves leftward or rightward (in the drawing.

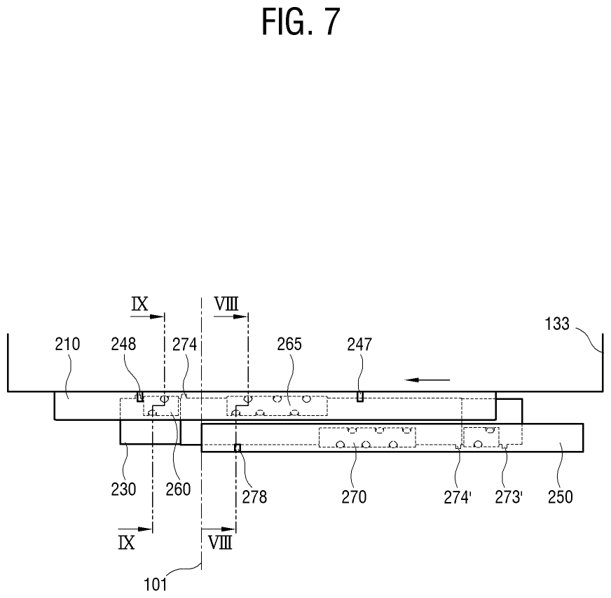

In more detail, the first interlocker 247 is in contact with the upper movement retainer 265 provided on the movement member 210 and moves the upper movement retainer 265 until the upper movement retainer 265 is stopped by a second projection 274 of upper stationary stoppers 273 and 274 (to be described later) in a case where the movement member 210 moves leftward to pull out the drawer 133 as shown in FIGS. 7 and 10. When the upper movement retainer 265 is stopped by the second projection 274, the first interlocker 247 continuously pushes the upper movement retainer 265 so that the middle member 230 can move leftward.

In a case where the movement member 210 moves rightward to push in the drawer 133, the second interlocker 248 is in contact with the upper stationary retainer 260 stationarily provided on the movement member 210 so that the middle member 230 can move rightward through the upper stationary retainer 260.

To make smooth relative movement between the movement member 210 and the middle member 230 when the drawer 133 is pulled out or pushed in, the rolling element 245 is provided to be in the rolling-contact with the movement member 210 and the middle member 230.

In more detail, as shown in FIGS. 5 and 6, the rolling element 245 is interposed between the movement member 210 and the middle member 230. In other words, the rolling element 245 is disposed along the track groove 232a of the upper rolling-contact surface 232 and the track groove 237a of the upper load support surface 237 of the first load supporting portion 236 within the movement sliding space 211 of the movement member 210.

The rolling element 245 disposed in the track groove 232a of the upper rolling-contact surface 232 is maintained to be freely movable within a space between the track groove 232a of the upper rolling contact surface 232 and the movement member 210 by the upper movement retainer 265.

The upper movement retainer 265 is formed to have the C′-shaped cross-section corresponding to the movement member 210, and includes a plurality of holes 266 to accommodate the rolling element 245. The plurality of holes 266 may, for example, include twelve holes 266 to accommodate a total of twelve rolling elements 245 as three holes 266 are formed in each of four lengthwise track grooves 232a of the upper rolling-contact surface 232. There are no limits to the number of holes 266, and the number of holes 266 may be varied depending on design. For example, at least one hole may be provided in each of the two track grooves 232a formed at the upper opposite sides among the four lengthwise track grooves 232a so that only the two track grooves 232a formed at the upper opposite sides can accommodate the rolling elements 245. Further, at least one hole may be designed to be provided corresponding to each of the four lengthwise track grooves 232a.

The upper movement retainer 265 is prevented from moving outward and separating from the movement sliding space 211 by an upper movement limit stopper 276 formed on the upper right portion of the upper rolling-contact surface 232. The upper movement limit stopper 276 may be embodied by a projection formed to have a height to prevent the movement of the upper movement retainer 265.

The rolling element 245 placed in the track groove 237a on the upper load support surface 237 of the first load supporting portion 236 is maintained to freely roll within the space between the movement member 210 and the upper load support surface 237 by the upper stationary retainer 260.

Like the upper movement retainer 265, the upper stationary retainer 260 is formed to have the C′-shaped cross-section corresponding to the movement member 210, and includes the plurality of holes 266 to accommodate the rolling element 245. The plurality of holes 261 may, for example, include four holes 261 to accommodate a total of four rolling elements 245 as one hole 261 is formed in each of four lengthwise track grooves 237a of the upper load support surface 237. There are no limits to the number of holes 266, and the number of holes 261 may be varied depending on design. For example, at least one hole may be provided in each of the two track grooves 237a formed at the upper opposite sides among the four lengthwise track grooves 237a. Further, at least one hole may be designed to be provided corresponding to each of the four lengthwise track grooves 237a.

The upper stationary retainer 260 is stationarily kept within the movement sliding space 211 by the upper stationary stoppers 273 and 274 formed on the top of the upper load support surface 237. The upper stationary stoppers 273 and 274 may be embodied by first and second projections 273 and 274 formed to have a height to prevent leftward and rightward movement of the upper stationary retainer 260, which are provided at the left and right portions of the upper stationary retainer 260.

Like this, the rolling element 245 is maintained by the upper movement retainer 265 and the upper stationary retainer 260, so that the rolling element 245 can be stably disposed between the movement member 210 and the middle member 230.

The rolling element 245 of the upper movement retainer 265 and the rolling element 245 of the upper stationary retainer 260 have the same size. In this case, the rolling elements 245 may be embodied by balls having the same diameter. However, there are no limits to the shape of the rolling element 245, and the rolling element 245 may be shaped like the roller or the like. Thus, the guide rail 200 does not need to include the rolling elements of different sizes. Further, the guide rail 200 employs the rolling elements 245 of the same size on the upper rolling contact surface 232 of the middle member 230 and thus equally maintain a degree of contact between the rolling element 245 and the movement member 210, thereby uniformizing the operation quality.

Further, the rolling element 295 of the upper movement retainer 265 and the rolling element 245 of the upper stationary retainer 260 may be made of different materials from each other. For example, the rolling element 245 of the upper movement retainer 265 may be embodied by a plastic ball, but the rolling element 245 of the upper stationary retainer 260 may be embodied by a steel ball. Thus, the rolling element 245 of the upper stationary retainer 260 can stably support the load of the drawer 133 while the drawer 133 is positioned in the critical pull-out section, and maintain a stable load supporting function without being broken even through it is used for a long time.

The stationary member 250 refers to an outer member that accommodates the middle member 230 to be slidable and is supported in the drawer accommodating room 131, which is fastened to the drawer accommodating room 131 through a frame 280. The stationary member 250 is extended corresponding to the middle member 230 along the pulling-out or pushing-in directions of the drawer 133.

Inside the stationary member 250, the stationary sliding space 251 is formed to form a track along which the lower portion of the middle member 230 moves. The lower rolling-contact surface 233 of the rolling contact portion 231 and the lower load support surface 238 of the first and second load supporting portions 236 and 236′ of the middle member 230 are movably inserted and placed inside the stationary sliding space 251.

The stationary member 250 is formed as a long member having a ‘C’-shaped cross-section opened upward. However, the disclosure is not limited to this, but may be designed to have another shape.

To make smooth relative movement between the middle member 230 and the stationary member 250 when the drawer 133 is pulled out or pushed in, the rolling element 245 is provided to be in the rolling-contact with the middle member 230 and the stationary member 250.

In more detail, as shown in FIGS. 5 and 6, the rolling element 245 is interposed between the middle member 230 and the stationary member 250. In other words, the rolling element 245 is disposed to be movable along the track groove 233a of the lower rolling-contact surface 233 and the track groove 238a of the lower load support surface 238 of the second load supporting portion 236′ within the stationary sliding space 251 of the stationary member 250.

The rolling element 245 disposed in the track groove 233a of the lower rolling-contact surface 233 is maintained to be freely movable within a space between the track groove 233a of the lower rolling contact surface 233 and the stationary member 250 by the lower movement retainer 270.

Like the track groove 233a of the upper rolling-contact surface 232, the track groove 233a of the lower rolling-contact surface 233 includes four lengthwise track grooves 233a corresponding to four corners of the cross-section of the lower rolling-contact surface 233. Further, alternatively, instead of the four lengthwise track grooves 233a, the track groove 233a may include three lengthwise track grooves (not shown) to be in the rolling-contact with the rolling element 245 in three directions corresponding to three corners of the cross-section of the lower rolling-contact surface 233, or two lengthwise track grooves (not shown) to be in the rolling-contact with the rolling element 245 in two directions corresponding to three corners of the cross-section.

The lower movement retainer 270 is formed to have a ‘C’-shaped cross-section opened upward corresponding to the stationary member 210, and includes a plurality of holes 271 to accommodate the rolling element 245. The plurality of holes 271 may, for example, include twelve holes 271 to accommodate a total of twelve rolling elements 245 as three holes 271 are formed in each of four lengthwise track grooves 233a of the lower rolling-contact surface 233. There are no limits to the number of holes 271, and the number of holes 271 may be varied depending on design. For example, at least one hole may be provided in each of the two track grooves 233a formed at the lower opposite sides among the four lengthwise track grooves 233a. Further, at least one hole may be designed to be provided corresponding to each of the four lengthwise track grooves 233a.

The lower movement retainer 270 may be movable forward and backward (i.e. leftward and rightward in the drawing) within the stationary sliding space 251 by the corresponding rolling element 245 being in the rolling-contact between the inner surface of the stationary member 250 and the track groove 233a of the lower rolling contact surface 233. The lower movement retainer 270 is prevented from separating outward from the left side of the stationary sliding space 251 by a lower movement limit stopper 278 formed on the left side of the inner surface of the stationary member 250. The lower movement limit stopper 278 may be embodied by a projection formed protruding from a left portion of the inner surface of the stationary member 250 and having a height to prevent the movement of the lower movement retainer 270.

The rolling element 245 placed in the track groove 238a on the lower load support surface 238 of the second load supporting portion 236′ is maintained to freely move within the space between the stationary member 250 and the lower load support surface 238 by the lower stationary retainer 275.

Like the lower movement retainer 270, the lower stationary retainer 275 is formed to have the C′-shaped cross-section corresponding to the stationary member 250, and includes a plurality of holes 276 to accommodate the rolling element 245. The plurality of holes 276 may, for example, include four holes 276 to accommodate a total of four rolling elements 245 as one hole 276 is formed in each of the four lengthwise track grooves 238a of the lower load support surface 238. There are no limits to the number of holes 276, and the number of holes 276 may be varied depending on design. For example, at least one hole may be provided in each of the two track grooves 238a formed at the upper opposite sides among the four lengthwise track grooves 238a. Further, at least one hole may be designed to be provided corresponding to each of the four lengthwise track grooves 238a.

The lower stationary retainer 275 is stationarily kept within the stationary sliding space 251 by the lower stationary stoppers 273′ and 274′ (see FIGS. 7 and 10) formed on the top of the lower load support surface 238. The lower stationary stoppers 273′ and 274′ may be embodied by first and second projections 273′ and 274′ formed to have a height to prevent leftward and rightward movement of the lower stationary retainer 275, which are provided at the left and right portions of the lower stationary retainer 275.

Like this, the rolling element 245 is maintained by the lower movement retainer 270 and the lower stationary retainer 275, so that the rolling element 245 can be stably disposed between the stationary member 250 and the middle member 230.

The rolling element 245 of the lower movement retainer 270 and the rolling element 245 of the upper stationary retainer 275 have the same size as the rolling element 295 of the upper movement retainer 265 and the rolling element 245 of the upper stationary retainer 260. Thus, the guide rail 200 does not need to include the rolling elements of different sizes. Further, the guide rail 200 employs the rolling elements 245 of the same size on the lower rolling contact surface 233 of the middle member 230 and thus equally maintain a degree of contact between the rolling element 245 and the stationary member 250, thereby uniformizing the operation quality.

Further, the rolling element 245 of the lower movement retainer 270 may be different in material from the rolling element 245 of the lower stationary retainer 275. For example, the rolling element 245 of the lower movement retainer 270 may be embodied by a plastic ball like the rolling element 245 of the upper movement retainer 265, and the rolling element 245 of the lower stationary retainer 275 may be embodied by a steel ball like the rolling element 245 of the upper stationary retainer 260. Thus, as described above with reference to FIG. 16, the rolling element 245 of the lower stationary retainer 275 can stably support the load of the drawer 133 even when a user instantaneously lifts up the front end of the drawer 133 while the drawer 133 is moved to the critical push-in section, and maintain a stable load supporting function without being broken even through it is used for a long time.

In the foregoing guide rail 200 according to an embodiment of the disclosure, the middle member 230 is supported in the drawer accommodating room 131 through the stationary member 250. However, the disclosure is not limited to this. For example, the guide rail 200 of the disclosure may not include the stationary member 250, and thus the middle member 230 may be directly fastened to and supported on the frame. In this case, the middle member 230 may be configured to exclude the lower rolling-contact surface 233 and the lower load support surface 238 from the rolling contact portion 231 and the first and second load supporting portions 236 and 236′.

In the refrigerator 100 with the foregoing guide rail 200 according to an embodiment of the disclosure, operations of pulling out and pushing in the drawer will be described below with reference to FIGS. 2 to 4 and FIGS. 7 to 12.

First, when a user holds and pulls the handle 137 of the drawer 133 forward, the movement member 210 to which the drawer 133 is fastened is moved leftward.

As the movement member 210 moves leftward, the first interlocker 247 positioned at the right portion on the inner surface of the movement member 210 is in contact with the upper movement retainer 265 provided on the movement member 210 and moves the upper movement retainer 265 leftward as shown in FIG. 7.

In this case, the center of gravity in the drawer 133 acts on the upper movement retainer 265 positioned between the movement member 210 and the middle member 230 within the drawer accommodating room 131, so that the rolling element 245 of the upper movement retainer 265 can be in the rolling-contact with the movement member 210 and the middle member 230 (see FIG. 8), and the rolling element 245 of the upper stationary retainer 260 can be maintained leaving a predetermined space as much as the predetermined gap G from the movement member 210 without contact (see FIG. 9).

In this status, the movement member 210 moves leftward until the upper movement retainer 265 becomes contact with the second projection 274 of the upper stationary stoppers 273 and 274 of the upper stationary retainer 260 by the first interlocker 247. In this case, the movement member 210 moves being in the rolling-contact with the middle member 230 through the rolling element 245 of the upper movement retainer 265, and the middle member 230 moves being in the rolling-contact with the stationary member 250 through the rolling element 245 of the lower movement retainer 270.

Then, when the upper movement retainer 265 is in contact with the second projection 274 of the second stationary stoppers 273 and 274, the upper movement retainer 265 does not move any more and the force acting on the upper movement retainer 265 is transferred to the middle member 230 by the first interlocker 247. In result, the middle member 230 moves leftward together with the upper movement retainer 265. Further, in this case, the lower movement retainer 270 is in contact with the second projection 274′ of the lower stationary stoppers 273′ and 274′ and moves leftward together with the middle member 230 by the second projection 274′.

Then, when the lower movement retainer 270 of the middle member 230 is in contact with the lower movement limit stopper 278 as shown in FIG. 10 and thus its movement is restricted, i.e. when the drawer 133 reaches the critical pull-out section, the movement member 210 and the middle member 230 stop moving.

In this case, force F caused by the load of the drawer 133 to act on a front-end portion of the movement member 210 is increased as the drawer 133 moves closer to the critical pull-out section, and maximized at the moment when the drawer 133 reaches the critical pull-out section.

Therefore, because the first load supporting portion 236 of the middle member 230 has a height difference as much as a predetermined gap from the rolling contact portion 231, the movement member 210 is slightly inclined as shown in FIG. 12 so that its bottom in the front-end portion can be in contact with both the rolling element 245 of the upper stationary retainer 260 and the rolling element 245 of the upper movement retainer 265. In result, it is possible to stably support the load of the drawer 133.

Then, when the drawer 133 starts moving again from the critical pull-out section into the drawer accommodating room 131 as a user holds and pushes the handle 137 of the drawer 133, the rolling element 245 positioned corresponding to the upper load support surface 237 of the first load supporting portion 236 is in the rolling-contact with the upper load support surface 237 and the inner surface of the movement member 210, thereby assisting the movement of the movement member 210.

Then, when the force F acting on the front-end portion of the movement member 210 is released by a user's operation of pushing the drawer 133, the inner surface in the front-end portion of the movement member 210 is separated from the contact with the rolling element 245 of the upper stationary retainer 260 and returned to the horizontal position, so that only the rolling element 245 of the upper movement retainer 265 can be in the rolling-contact with the movement member 210 and the middle member 230.

As the movement member 210 fastened to the drawer 133 continuously moves rightward, the second interlocker 248 provided in the left portion on the inner surface of the movement member 210 becomes in contact with the upper stationary retainer 260 stationarily provided on the movement member 210, thereby moving the middle member 230 rightward. In this case, the lower movement retainer 270 moves together with the middle member 230 by the rolling element 245 being in the rolling-contact with the lower rolling-contact surface 233. Then, when a user fully moves the drawer 133 up to a critical push-in position, the pushing-in operation of the drawer 133 is completed.

In this case, the rolling element 240 of the lower stationary retainer 275 is in the rolling-contact with the lower load supporting surface 238 of the second load supporting portion 236′ and the inner surface of the stationary member 250 in between the corresponding surfaces even though a user instantaneously lifts up the front end of the drawer 133 while the drawer 133 is moved to the critical push-in section (see FIG. 16). Therefore, it is possible to relieve a shock applied to the rolling element 240 being in the rolling-contact with the lower rolling-contact surface 233.

As described above, in the guide rail 200 according to an embodiment of the disclosure, and the drawer-type storage 130 and the refrigerator 100 including the same, a degree of contact between the rolling element 245 and the members 210 and 230 is equally maintained while the guide rail 200 works, thereby uniformizing the operation quality. Further, when the drawer 133 is positioned in the critical pull-out section and/or the critical push-in section, the rolling element 245 is further in contact with the lower load support surface 238 of the second load supporting portion 236′ and the upper load support surface 237 of the first load supporting portion 236 having the height difference as much as the predetermined gap from the upper rolling contact surface 232 of the rolling contact portion 231, thereby stably supporting the load of the drawer 133.

Although detailed descriptions of the disclosure have been made through a few exemplary embodiments, it will be appreciated that the disclosure is not limited to these embodiments and various changes may be made without departing from the scope defined in the appended claims.

1. A refrigerator comprising:
a drawer accommodating room;
a drawer accommodated in the drawer accommodating room; and
a rail configured to guide the drawer to be pulled out of or pushed into the drawer accommodating room,
wherein the rail comprises:
a first member extended along pulling-out or pushing-in directions of the drawer and supporting the drawer;
a second member extended corresponding to the first member and supported in the drawer accommodating room of the refrigerator; and
a plurality of rolling elements arranged between the first member and the second member and being in rolling-contact with the first member and the second member when the drawer is pulled out or pushed in, and
the second member comprises a load support surface having an inward height difference as much as a predetermined gap from a rolling contact surface with which at least one second rolling element different from a first rolling element among the plurality of rolling elements is in rolling-contact so that at least one of the first rolling elements among the plurality of rolling elements is in contact with the first member and the second member and support a load of the drawer in a state that the drawer is positioned in at least one of a critical pull-out section or a critical push-in section.

2. The refrigerator according to claim 1, wherein the plurality of rolling elements are of the same size.

3. The refrigerator according to claim 1, wherein the at least one first rolling element and the at least one second rolling element are different in material.

4. The refrigerator according to claim 1, wherein the at least one first rolling element comprises higher stiffness than the at least one second rolling element.

5. The refrigerator according to claim 1, wherein the second member comprises a load supporting portion formed with the load support surface, of which stiffness is higher than a rolling contact portion formed with the rolling contact surface.

6. The refrigerator according to claim 1, wherein the second member comprises a load supporting portion formed with the load support surface separately from a rolling contact portion formed with the rolling contact surface.

7. The refrigerator according to claim 1, further comprising:
a movement retainer freely movable in a space between the first member and the rolling contact surface, and accommodating the at least one different second rolling element; and
a stationary retainer stationarily placed in a space between the first member and the load support surface, and accommodating the at least one first rolling element.

8. The refrigerator according to claim 7, wherein the load support surface comprises a first stopper to restrict movement of the stationary retainer.

9. The refrigerator according to claim 7, wherein the rolling contact surface comprises a second stopper to restrict movement of the movement retainer.

10. The refrigerator according to claim 7, wherein the stationary retainer comprises a ‘C’-shape so that at least two first rolling elements are in contact with the first member and the second member.

11. The refrigerator according to claim 7, wherein the movement retainer comprises a ‘C’-shape so that at least two second rolling elements are in contact with the first member and the second member.

12. The refrigerator according to claim 1, wherein the load support surface comprises a plurality of grooves having a depth as much as the predetermined gap on the rolling contact surface and accommodating the at least one first rolling element.

13. The refrigerator according to claim 1, wherein the predetermined gap ranges from 0.01 mm to 0.1 mm (±tolerance).

14. The refrigerator according to claim 1, wherein the predetermined gap is large enough to prevent the at least one second rolling element together with the at least one first rolling element from exceeding a yield point based on a compressive force received from the first and second members in the state that the drawer is positioned in the critical pull-out section.

15. The refrigerator according to claim 1, further comprising:
a frame fastened to the drawer accommodating room;
a third member supported on the frame; and
a plurality of third rolling elements arranged between the third member and the second member,
wherein the second member is configured to be in rolling-contact with the plurality of third rolling elements and slide the third member when the drawer is pulled out or pushed in.
